(19) United States
(12) Patent Application Publication
(10) Pub. No.: US 2024/0254843 A1
(43) Pub. Date: Aug. 1, 2024

(54) CABLE PROTECTION DEVICE

(71) Applicant: Toolserv AS, Stavanger (NO)

(72) Inventor: Geir Lunde, Sandnes (NO)

(73) Assignee: Toolserv AS, Stavanger (NO)

(21) Appl. No.: 18/561,096

(22) PCT Filed: May 24, 2022
(86) PCT No.: PCT/NO2022/050115

§ 371 Date: Nov. 15, 2023

(30) Foreign Application Priority Data
May 31, 2021 (NO) 20210686

(51) Int. Cl. E21B 17/10

(52) U.S. Cl. CPC E21B 17/1085

(57) ABSTRACT

A cable protection device is for protecting a cable running along a tubular body having a coupling having two side edges. The cable protection device has a body for partly enclosing the tubular body circumferentially. The body is provided with a protective portion having an inside, for enclosing a portion of the cable and a clamping portion having a contact surface for close contact with the tubular body, and also having an outside. The cable protection device further has a fastening device including a flexible member for strapping the body to the tubular body and a tightening mechanism for tightening the flexible member.

### CROSS-REFERENCE TO RELATED APPLICATIONS

This application is the U.S. national stage application of International Application PCT/NO2022/050115, filed May 24, 2022, which international application was published on Dec. 8, 2022, as International Publication WO 2022/255878 in the English language. The International Application claims priority of Norwegian Patent Application No. 20210686, filed May 31, 2021. The international application and Norwegian application are both incorporated herein by reference, in entirety.

### FIELD

The invention concerns a cable protection device for protecting cables or lines running along a pipe or a tubular body, such as a well pipe. The cable protection device is for clamping the cables to the tubular body and protect them. The cable protection device disclosed herein is particularly adapted to protect cables passing over pipe joints, i.e. running over the coupling connecting two pipes.

### BACKGROUND

The term “cable” is used herein as a collective term for ESP-cables, control lines, hydraulic lines and other cables and sensors which may be run downhole along a well pipe.

There are many known types of fasteners or clamps for fastening cables to pipes, for instance simple metallic straps. There are also known many types of cable protection devices which protect cables running over pipe joints and also strap the cables to the pipe.

Patent publication GB 2512365 A discloses an example of a known cable protection device. This device consists of a housing member which is hinged to a strap member, and the housing has a conduit for enveloping control lines.

Patent publication WO 2019202163 A1 discloses a gripper for a cable protector. The publication shows two grippers connected by a spine which protects cables running past a pipe joint.

Patent publication WO 2004064215 A1 shows another example of a cable clamp device which comprises first and second arcuate arms joined to each other with a hinge. A locking arm is pivotally joined by a hinge to the second arcuate arm, and a flexible wire loop is attached to the locking arm.

Patent publication ITUA20163802 A1 discloses a coupling and protection device for a cable arranged externally to a conduit. The device comprises a protective casing and coupling means associated and operatively connected to both longitudinal ends of the protective casing. The coupling means comprises a lever locking system.

Patent publication U.S. Pat. No. 4,601,334 A discloses control line protector for securing and protecting a control line or lines to the exterior of an oil well tubing string. The protector comprises a flexible steel strap to the ends of which a respective trunnion is attached, one of which trunnions is removably mounted. The trunnions are interconnected by two screws which may be rotated to draw the trunnions towards one another.

Patent publication RU190275U1 discloses a device to protect a power cable in a well. The device comprises a molded case, made in one piece with the cable channel and with a central channel. The device comprises arcuate clamping brackets.

Patent publication WO2005103544 A2 a cable clamp device.

Patent publication U.S. Pat. No. 6,023,027 A discloses a guard for cables that extend alongside a coupling in a tubing string.

One disadvantage of prior art cable protectors is that they can be complex both to produce and to install. Another disadvantage is that different sized cable protectors need to be provided for different sized pipes.

### SUMMARY

The invention has for its object to remedy or to reduce at least one of the drawbacks of the prior art, or at least to provide a useful alternative to prior art.

The object is achieved through features, which are specified in the description below and in the claims that follow.

The invention is defined by the independent patent claim. The dependent claims define advantageous embodiments of the invention.

More specifically, the invention relates to a cable protection device for protecting a cable running along a tubular body, the tubular body comprising a coupling having two side edges, the cable protection device comprising:
a body for partly enclosing the tubular body circumferentially, the body being provided with:
   a protective portion having an inside, for enclosing the cable; and
   a clamping portion comprising a contact surface for close contact with the tubular body, and an outside; and
a fastening device comprising
   a flexible member for strapping the body to the tubular body wherein the flexible member is partly arranged on the inside of the protective portion and partly arranged on the outside of the clamping portion, wherein the portion of the flexible member being arranged on the inside of the protective portion is configured for holding the cable securely between the protection device and the tubular body; and
   a tightening mechanism for tightening the flexible member.

When in use, the body of the cable protection device encloses the tubular body partly in the circumference of the tubular body. Ideally the body encloses up to half of the circumference of the tubular body. When arranged on the tubular body, the body of the cable protection device extends longitudinally along the tubular body. The protective portion of the body typically includes a longitudinal recess allowing the cable to stay protected between the body of the cable protection device and the tubular body to which the cable protection device is strapped. Since cables are particularly exposed to damage at the pipe connections, since the coupling of the pipe connection extends further out into the well bore than the rest of the tubing, it is important to protect the cables in this area.

The purpose of having the body enclose the tubular body only partly, is that the cable protection device may be arranged on the tubular body from the side, i.e., without having to slide it on from the pipe end. This gives a flexible solution and allows for easy changing of protection device in case of damage.

The flexible member straps the cable protection device to the tubular body and clamps, or traps, the cable between the tubular body and the body of the cable protection device. One purpose of the flexible member of the fastening device, is that the cable protection device may be strapped either to the coupling or to the pipe, depending on the shape and size of the cable protection device. Another purpose is that the flexible member allows the recess, or groove, of the protective portion of the body to be the same independent of the size and shape of the cable or cables to be protected. This is because the tightening mechanism and the flexible member make it possible to adjust the tightening of the body against the tubular body. If the cables are of smaller size, the flexible member may be tightened harder than if the cables are bigger. This way, the cables are held securely between the cable protection device and the tubular body. Having a fixed size and shape for the recess, makes the production of cable protection devices easier, and it makes the use of the cable protection device more flexible. The same kind of cable protection device may be used for different types of cables.

The flexible member may be a band, and the tightening of the band may be either stepless or stepwise. The flexible member may comprise polyphenylene sulfide (PPS). In particular, the flexible member may comprise glassfiber reinforced PPS. The flexible member may comprise ratchets, and the tightening mechanism may work similarly to the mechanism of a cable tie.

The tightening mechanism may be arranged on the inside of the body so that it is protected by the body of the cable protection device. The tightening mechanism may be fastened to the body of the cable protection device, or more preferably, it may be fastened to one end of the flexible member. If the tightening mechanism is fastened to the flexible member itself, the body of the cable protection device may comprise a trap or opening for holding the tightening mechanism, so that the flexible member may be thread into the body of the cable protection device from the end without the tightening mechanism until the tightening mechanism is trapped or secured or clicked into place in the body. The advantage of this is that the flexible member may easily be changed in case of damage. The purpose of the tightening mechanism is to tighten and lock the flexible member, so that the cable protection device is securely fastened around the tubular body.

The flexible member is partly arranged on the inside of the protective portion and partly arranged on the outside of the clamping portion. This allows for the flexible member to be in direct contact with the cables to be protected. Strapping the cables directly by the flexible member, while they are still protected by the protective portion of the cable protection device, has the advantage that cables of different sizes and shapes may be securely held by the cable protection device. This means that the same sized cable protection device may be used for different cables to be protected.

The clamping portion of the body may further comprise two shoulders, each for bearing against one of the side edges of the coupling, for preventing axial movement of the cable protection device along the tubular body.

The purpose of the shoulders preventing axial movement of the cable protection device is to keep the cable protection device itself in place, relative to the cable running over the coupling, making sure not to expose the cable to unnecessary wear. Cables running along downhole pipes, for instance, are particularly vulnerable when they pass over couplings, i.e., pipe joints, it is therefore an advantage to mount the cable protection device over the coupling, and make sure it does not move along the pipe in the longitudinal/axial direction.

The fastening device may comprise a further flexible member.

There are different possible embodiments of the cable protection device, and in one embodiment two flexible members may be provided. In this embodiment, one flexible member may be arranged on each side of the cable protection device for strapping the ends of the cable protection device to the tubular body. When the cable protection device is mounted at a pipe connection, over a coupling, the flexible members may be positioned one on each side of the coupling. It must be understood that depending on the size and shape of the body of the cable protection device, more than two flexible members may be provided for strapping the body to the tubular body. In one embodiment, the flexible members are arranged at the far ends of the cable protection device. The body of the cable protection device may typically extend in the axial direction of the tubular body to which it is going to be strapped, and in one embodiment, the body of the cable protection device may be provided with two arms for gripping the tubular body. The flexible members may be placed in connection with the arms. Each arm may for instance be provided with a recess for guiding the flexible member.

A groove may be provided in the contact surface and the cable protection device may further comprise a roller for fitting into the groove for providing extra tensioning of the flexible member in case the cable protection device is rotated.

The groove and the roller provide extra tensioning of the flexible member by way of the shape of the groove. Typically, the groove may be shaped so that it is deeper at a mid portion in which the roller is positioned when the cable protection device is first arranged on the tubular body. If the cable protection device is rotated after being strapped to the tubular body, the roller is forced into the more shallow side portion of the groove, and thus pushes the body of the cable protection device slightly outwards from the tubular body and adds to the tightening of the flexible member.

The roller may have a cam profile or it may be circular.

At least a portion of the contact surface of the clamping portion may be serrated.

The purpose of such a serrated portion of the contact surface is to prevent rotation of the cable protection device around the tubular body, or at least to make such rotation less likely. Rotation is already made difficult by the tight strapping of the cable protection device by means of the fastening device, and the serration works in synergy with the fastening device to further prevent rotation.

At least a portion of the contact surface of the clamping portion may be provided with a surface coating for increased friction between the contact surface and the tubular body.

Surface coating for increased friction is an alternative to the serration mentioned above and has the same purpose namely to further prevent rotation of the cable protection device. Such surface coating may include tungsten carbide coating, and such coating may include particles. Of course, there are other alternatives, such as rubber or other materials which give a higher friction. A skilled person would know which kind of materials would be suitable in this connection.

The cable protection device may further comprise an insert for being positioned between the contact surface and the tubular body, for providing extra friction.

Instead of a surface coating, an insert may be used for increasing friction between the contact surface of the cable protection device and the tubular body to which it is fastened. Such insert may comprise silicon carbide.

The cable protection device may further be provided with at least one sharp element arranged in connection with the contact surface, for gripping into the tubular upon tightening of the flexible member.

By the term “sharp element” is herein meant for instance a pointed element, like a set screw. Any element which may be arranged in connection with the contact surface and which is sharp, hard and small enough to bite into the surface of the tubular body, is suitable for this purpose. A set screw is given as an example of such an element.

### BRIEF DESCRIPTION OF THE DRAWINGS

In the following is described examples of preferred embodiments illustrated in the accompanying drawings, wherein:

FIG. 1 shows an embodiment of a cable protection device in perspective view;

FIG. 2 shows the body of the cable protection device in perspective view from another angle;

FIG. 3 shows a side view of the cable protection device of FIG. 1, mounted on a tubular body;

FIG. 4 shows a cross-section of FIG. 3;

FIG. 5 shows an end view of the body of the cable protection device arranged on a tubular body (cross-section of pipe and cables);

FIG. 6 illustrates the function of the elastic band of the cable protection device, and an example of how it may be arranged;

FIG. 7 shows a cross-section along the center line of the tubular body, of the tubular body and the cable protection device;

FIG. 8a shows an embodiment of the cable protection device provided with extra tightening means;

FIG. 8b shows the extra tightening means of FIG. 8a at a larger scale; and

FIG. 9 shows an embodiment of the cable protection device.

### DETAILED DESCRIPTION OF THE DRAWINGS

The figures are shown in a simplified and schematic manner, and details that are not important in order to highlight what is new about the invention may have been omitted from the figures. The various elements in the figures are not necessarily shown to scale relative to each other. Like or corresponding elements will be indicated by the same reference numeral in the figures.

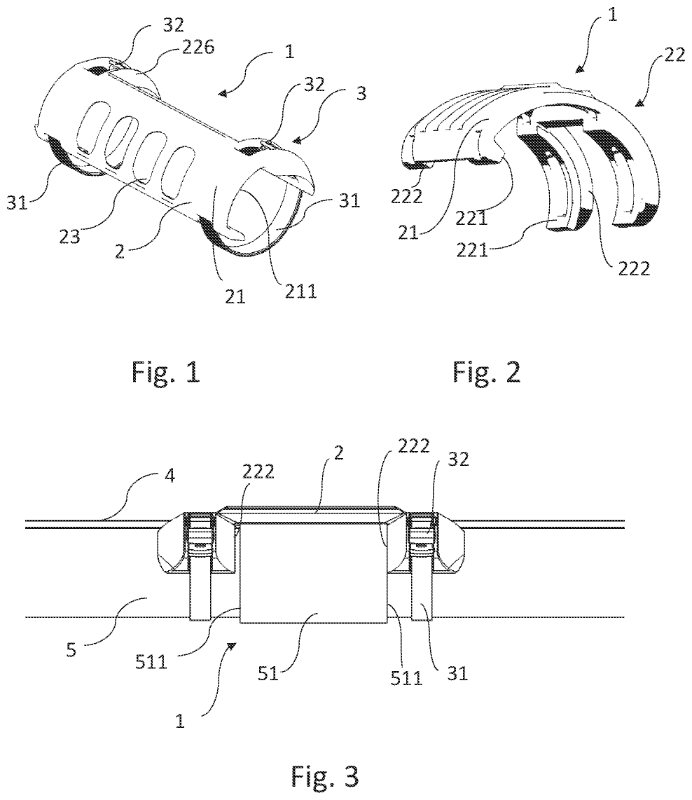

Reference is first made to FIGS. 1-3 which will be described together and which illustrate one embodiment of a cable protection device 1 as disclosed herein. The cable protection device 1 comprises a body 2 and a fastening device 3. The fastening device 3 comprises a flexible member 31 and a tightening mechanism 32. The flexible member 31 may be a band. The shown embodiment of the cable protection device 1 comprises two flexible members 31 and thus also two tightening mechanisms 32. The body 2 comprises two portions namely a protective portion 21 for enclosing a portion of a cable 4 running along a tubular body 5, see FIG. 3, and a clamping portion 22 comprising a contact surface 221 for close contact with the tubular body 5. The protective portion 21 has an inside 211, and the clamping portion 22 has an outside 226. In the shown embodiment the flexible member 31 runs along the inside 211 of the protective portion 21 and along the outside 226 of the clamping portion 22. This arrangement allows the flexible member 31 both to strap the body 2 to the tubular body 5 and to tighten directly against the cables 4 to be protected. On FIG. 2, the contact surface 221 and shoulder 222 are indicated on both sides of the protective portion 21. The tubular body 5 comprises a coupling 51 having two side edges 511. The body 2 is shown having openings 23 in the protective portion 21. These openings 23 are for reducing the amount of material needed for producing the cable protection device 1. The clamping portion 22 of the body 2 may be provided with shoulders 222 for bearing against the side edges 511 of the coupling 51.

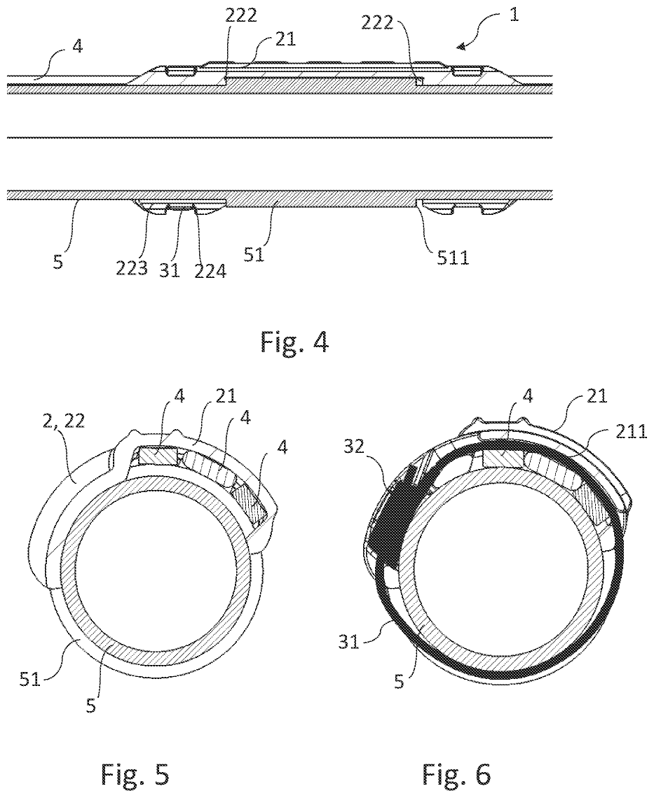

FIG. 4 shows a cross-section through a tubular body 5 and a coupling 51 whereon a cable protection device 1 is arranged. This Figure shows that an inner diameter of the cable protection device 1 is slightly bigger than an outer diameter of the tubular body 5 and that there are shoulders 222 on both sides of the protective portion 21. Furthermore, the figure shows that the cable 4 to be protected is running along the tubular body 5 and is protected by the protective portion 21 of the cable protection device 1. The flexible members 31 are placed in connection with arms 223. Each arm 223 shown here provided with a recess 224 for guiding the flexible member 31.

FIG. 5 shows the body 2 of the cable protection device 1 from the side when placed on the tubular body 5. Three cables 2 of different sizes are here shown protected by the protective portion 21 of the body 2, and it is further illustrated that the clamping portion 22 of the body 2 is in close contact with the tubular body 5.

FIG. 6 illustrates how the fastening device 3 may be arranged partly covered by and lining the body 2 for clamping the cables 4 to the tubular body 5. The flexible member 31 runs along the inside 211 of the protective portion 21 of the body 2, and straps the cables 4 directly. The flexible member 31 is here shown as a thick black line. A tightening mechanism 32 is provided for tightening the flexible member 31.

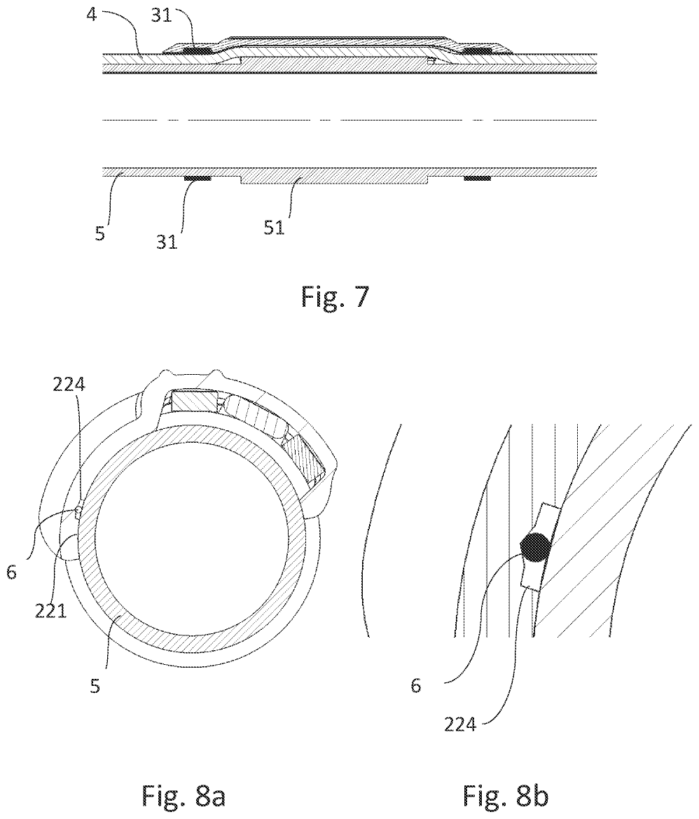

FIG. 7 is a cross section through the centre line of the tubular body 5, further illustrating the flexible members 31 clamping the cable 4 to the tubular body 5.

In addition to the features already described hereinabove for FIG. 5, FIG. 8a shows an embodiment of the cable protection device 1 wherein a tensioning means is provided in the form of a groove 224 and a roller 6. The groove 224 is provided in the contact surface 221 of the clamping portion 22 of the body 2. The groove 224 can be seen in more detail on FIG. 8b. The groove 224 is provided with a slightly deeper middle portion wherein the roller 6 is positioned. Whenever the cable protection device 1 is rotated, the roller 6 will be forced out of the deeper middle portion of the groove 224 and thereby pushes the body 2 radially out from the tubular body 5, consequently tensioning the flexible members 31.

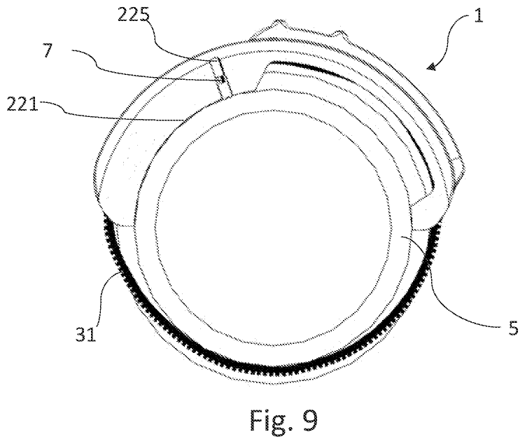

FIG. 9 illustrates further possible variations of some features of the cable protection device 1. In this embodiment, the flexible member 31 of the fastening device 3 is shown with a stepped surface providing stepwise tightening. Furthermore, in this embodiment a bore 225 is provided in the contact surface 221. Inside said bore 225 is provided a sharp element 7, for instance a set screw. It must be understood that a different sharp element could have been arranged on the contact surface 221 or, as shown here, in the bore 225 in the contact surface 221. The purpose of the sharp, or pointed, element 7 is to provide a grip in the tubular body 5, for preventing rotation of the cable protection device 1. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A cable protection device for protecting a cable running along a tubular body, the tubular body comprising a coupling having two side edges, the cable protection device comprising:
a body for partly enclosing the tubular body circumferentially, the body being provided with:
a protective portion having an inside, for enclosing the cable; and
a clamping portion comprising a contact surface for close contact with the tubular body, and an outside; and
a fastening device comprising:
a flexible member for strapping the body to the tubular body wherein the flexible member is partly arranged on the inside of the protective portion and partly arranged on the outside of the clamping portion, wherein the portion of the flexible member being arranged on the inside of the protective portion is configured for holding the cable securely between the protection device and the tubular body; and
a tightening mechanism for tightening the flexible member.

2. The cable protection device according to claim 1, wherein the clamping portion of the body further comprises two shoulders, each for bearing against one of the side edges of the coupling, for preventing axial movement of the cable protection device along the tubular body.

3. The cable protection device according to claim 1, wherein the fastening device comprises a further flexible member.

4. The cable protection device according to claim 1, wherein a groove is provided in the contact surface and the cable protection device further comprises a roller for fitting into the groove for providing extra tensioning of the flexible member in case the cable protection device is rotated.

5. The cable protection device according to claim 4, wherein the roller has a cam profile.

6. The cable protection device according to claim 1, wherein at least a portion of the contact surface of the clamping portion is serrated.

7. The cable protection device according to claim 1, wherein at least a portion of the contact surface of the clamping portion is provided with a surface coating for increased friction between the contact surface and the tubular body.

8. The cable protection device according to claim 1, further comprising an insert for being positioned between the contact surface and the tubular body, for providing extra friction.

9. The cable protection device according to claim 1, further provided with at least one sharp element arranged in connection with the contact surface, for gripping into the tubular upon tightening of the flexible member.

10. The cable protection device according to claim 2, wherein at least a portion of the contact surface of the clamping portion is provided with a surface coating for increased friction between the contact surface and the tubular body.

11. The cable protection device according to claim 3, wherein at least a portion of the contact surface of the clamping portion is provided with a surface coating for increased friction between the contact surface and the tubular body.

12. The cable protection device according to claim 4, wherein at least a portion of the contact surface of the clamping portion is provided with a surface coating for increased friction between the contact surface and the tubular body.

13. The cable protection device according to claim 5, wherein at least a portion of the contact surface of the clamping portion is provided with a surface coating for increased friction between the contact surface and the tubular body.

14. The cable protection device according to claim 2, further comprising an insert for being positioned between the contact surface and the tubular body, for providing extra friction.

15. The cable protection device according to claim 3, further comprising an insert for being positioned between the contact surface and the tubular body, for providing extra friction.

16. The cable protection device according to claim 2, further provided with at least one sharp element arranged in connection with the contact surface, for gripping into the tubular upon tightening of the flexible member.

17. The cable protection device according to claim 3, further provided with at least one sharp element arranged in connection with the contact surface, for gripping into the tubular upon tightening of the flexible member.

18. The cable protection device according to claim 2, wherein the fastening device comprises a further flexible member.

19. The cable protection device according to claim 2, wherein a groove is provided in the contact surface and the cable protection device further comprises a roller for fitting into the groove for providing extra tensioning of the flexible member in case the cable protection device is rotated.

20. The cable protection device according to claim 3, wherein a groove is provided in the contact surface and the cable protection device further comprises a roller for fitting into the groove for providing extra tensioning of the flexible member in case the cable protection device is rotated.
